(19) United States
(12) Patent Application Publication
(10) Pub. No.: US 2026/0336375 A1
(43) Pub. Date: Oct. 29, 2026

(54) BATTERY UNIT FOR A VEHICLE

(71) Applicant: AUTOTECH ENGINEERING S.L., Amorebieta-Etxano (ES)

(72) Inventors: Oriol MUNT FERRÀ, Olesa de Montserrat, Barcelona (ES); Maria Isabel BLANCO GONZALEZ, Vigo, Pontevedra (ES); Alfredo VERDE SÁNCHEZ, Barcelona (ES)

(21) Appl. No.: 19/112,432

(22) PCT Filed: Oct. 4, 2023
(86) PCT No.: PCT/EP2023/077471

§ 371 Date: Mar. 17, 2025

(30) Foreign Application Priority Data
Oct. 6, 2022 (EP) 22382941.7

(51) Int. Cl. B60K 1/04; B60L 50/64; B60L 58/10; H01M 10/42; H01M 10/613; H01M 10/625; H01M 10/647; H01M 10/653; H01M 10/6567; H01M 50/209; H01M 50/229; H01M 50/276; H01M 50/503; H01M 50/505

(52) U.S. Cl. CPC B60K 1/04; B60L 50/64; B60L 58/10; H01M 10/425; H01M 10/613; H01M 10/625; H01M 10/647; H01M 10/653; H01M 10/6567; H01M 50/209; H01M 50/229; H01M 50/276; H01M 50/503; H01M 50/505; H01M 2010/4271; H01M 2220/20

(57) ABSTRACT

The present disclosure relates to a battery unit for a vehicle. The battery unit comprises a battery tray made of a composite material and defining an interior space configured to receive a battery comprising one or more battery cells. Further, the interior space is delimited by a bottom wall and one or more lateral walls. Additionally, the battery unit comprises a top cover configured to close the battery tray, wherein a cooling system for cooling the battery is integrated. The present disclosure further relates to battery systems and vehicles including one or more battery units.

The present application claims the benefit of European patent application nº 22 382 941.7 filed on Oct. 6, 2022. The present disclosure relates to battery units for vehicles. More particularly, the present disclosure relates to battery units comprising a battery tray made of composite material and a top cover comprising a cooling system. The present disclosure further relates to battery systems including one or more battery units and vehicles including such battery systems.

### BACKGROUND

Vehicles such as cars incorporate a structural skeleton designed to withstand all loads that the vehicle may be subjected to during its lifetime. The structural skeleton or “Body In White” (BIW) is further designed to withstand and absorb impacts, in case of e.g. collisions with other cars. The structural skeleton is also designed to be as lightweight as possible in order to reduce the emission of pollutants such as CO₂ to the environment or to reduce the consumption of electricity in an electric vehicle.

The structural skeleton or BIW of a car may for instance include bumpers, pillars (e.g. A-pillar, B-pillar, C-pillar), side impact beams and rocker panels. These and other structural members may have one or more regions with a substantially U-shaped (also known as “hat”-shaped) cross section. These structural members may be manufactured in a variety of ways and may be made of a variety of materials. For instance, rocker panels may be made of steel, particularly Ultra-High Strength Steels (UHSS) and may be manufactured through press hardening.

Ultra-High Strength Steels (UHSS) exhibit optimized maximum strength per weight unit and advantageous forming properties in the automotive industry, for the structural framework of the vehicle or at least a number of its components. In the present disclosure, an UHSS may be regarded as a steel with a maximum tensile strength (after hot stamping) of at least 1000 MPa, preferably up to about 1500 MPa or up to 2000 MPa or more. An example of an UHSS used in the automotive industry is boron steel, e.g. 22MnB5 steel.

Processing a component for a vehicle may comprise forming of a metal plate, in particular a steel plate, in order to give the plate a desired shape. One process that is used particularly in the automotive industry is Hot Forming Die Quenching (HFDQ). In the HFDQ process, a steel blank is heated to above an austenization temperature, above Ac1 or above Ac3. After heating to above the austenization temperature, the blanks are placed in a hot forming press. The blanks are deformed and at the same time are quenched (rapidly cooled down). Cooling down may typically occur at a rate that is higher than a so-called critical cooling rate.

The rapid development of electric vehicles (EVs) and hybrid vehicles has forced the industry to design new car components, e.g. for weight reduction to achieve improved vehicle range, and for accommodating and protecting new car components among others. Structural components with new geometries and alternative materials are being manufactured and integrated into EVs to accomplish safety and weight reduction goals. Although reference will herein be made generically to electric vehicles or EVs, this is expressly intended to cover hybrid vehicles as well.

Traction batteries are an essential part of the EVs and are configured to provide power to an electric motor of the vehicle. The electronic and chemical nature of these batteries makes them particularly sensitive to high mechanical loads, e.g. crash impacts, and to high working temperatures. To extend battery lifespan, the automotive industry has put considerable effort into providing battery enclosures and load bearing structures suitable for EVs that combine battery protection and battery cooling. Thus, a wide range of battery components have been designed and developed during the last years to accommodate and to (mechanically and thermally) protect traction batteries.

Steel battery boxes or battery trays have been developed for this purpose. Also polymeric (plastic) or composite components are known. Although plastics and composites may be lighter than metallic components, they need to be designed and dimensioned for protection against severe impacts. Further, appropriate cooling systems have to be provided to keep battery temperature within acceptable ranges, while reducing weight of the overall battery system.

The present disclosure aims to provide improvements in the structures for protection of a battery for cars.

### SUMMARY

In a first aspect, a battery unit for a vehicle is provided. The battery unit comprises a battery tray made of a composite material. The battery tray defines an interior space configured to receive a battery comprising one or more battery cells. The battery tray is delimited by a bottom wall and one or more lateral walls. Further, the battery unit comprises a top cover configured to close the battery tray. Additionally, a cooling system for cooling the battery is integrated in the top cover.

The composite battery tray can provide a lightweight structure for the battery unit. Further, the composite material may be chosen to provide tailored mechanical strength, e.g., the composite material may have a higher strength in one direction than in other direction. Additionally, the introduction of a top cover including a cooling system integrated into it provides efficient cooling to the battery and, at the same time, reduces overall weight of the battery unit by reducing redundant layers of material. Thus, the battery unit provided has the lightness benefit from units made of composite or polymer materials, whereas at the same time it includes a cooling system arranged integrally within the battery unit in a weight saving configuration. Further, the composite battery tray may integrate several functionalities in one single component, e.g. the composite manufacturing process may facilitate the integration of different components in a single mold. The composite battery tray may in examples entirely replace a welded steel sub-assembly.

Throughout the present disclosure, “electric vehicles” or “hybrid vehicles” may be understood to encompass any vehicle having a traction battery at least partially configured to provide power to an electric power train of the vehicle.

Also, throughout the present disclosure, references to the “mechanical properties of a structure” may be understood as the mechanical properties of the material forming said structure. Therefore, unless otherwise stated, comparisons of mechanical properties of structures, components, or others, are directed to the material and not to the geometry, or other particularities, of the same.

In examples, the composite material used to form the battery tray may comprise glass fiber, although other materials such as carbon fiber, or aramid fibers may also be used.

In some examples, the battery tray may be made of a sheet molding compound. The sheet molding compound is a composite material provided in sheet form. The sheet is generally made by extending a resin paste into a surface, over which chopped fibers are dispensed. Then, another layer of resin is added on top of the chopped fibers and the sheet is compacted and stored while it cures.

In examples, the battery tray may comprise cross-members configured to separate the battery cells. Further, the cross-members may increase the strength of the battery tray against e.g. bending loads. Additionally, the cross-members may serve to provide stability to the battery cells while mounting them in the battery tray. For example, cross-members located along the battery tray with an offset to separate groups of battery cells, e.g. five cells or more, may facilitate the positioning of the battery cells per groups.

In some examples, the battery tray comprises brackets configured to connect the battery tray with a vehicle framework. The brackets may be located at the lateral walls and be manufactured integrally with the battery tray or may be inserted afterwards, e.g. using fasteners, welding or adhesives among others. In examples, the brackets may be located at two opposite lateral walls of the battery tray to provide stability to the connection with the vehicle framework.

In examples, the top cover is configured to at least partially seal the battery tray. For example, the top cover may be configured to limit the liquid ingress and liquid egress to/from the battery tray. Thus, the top cover may protect the battery against the ingress of external particles and liquid that may damage the battery cells, and may also contain liquids that may be present in the battery. Thus, the top cover may act as a cooling element and as a sealant plate, reducing the number of components of the battery unit and associated weight.

In some examples, the top cover may comprise a seal substantially along a perimeter of the top cover. Further, the seal may be or comprise an adhesive to adhere to at least one of the top cover and battery tray. In addition, the seal may comprise a thermal conductivity above 1 W·m⁻¹·K⁻¹, and more precisely above 1,5 W·m⁻¹·K⁻¹. In further examples, the top cover may comprise a seal over substantially all the interior surface of the top cover. For example, the seal may form a thin film between the top cover and the battery tray and battery cells inside the battery tray.

In some examples, the cooling system comprises one or more cooling channels configured to contain a liquid coolant. The cooling channels may have an input port and an output port to introduce coolant at relatively low temperature and extract coolant at relatively high temperature, respectively. The heated up coolant may be cooled again by a heat exchanger before reintroduction into the battery box for cooling.

The composition of the coolant may be chosen to obtain a coolant with high specific heat capacity, i.e. high heat capacity per mass unit, or to obtain a coolant with high latent heat, i.e. high heat absorption during a phase transformation, and a phase transition close to the working temperature of the battery unit. Thus, the cooling system with cooling channels may keep the operational temperature of the battery below the critical temperature at which the battery may experience thermal runaway.

A thermal runaway may be understood as a chemical chain reaction that occurs within a battery cell after reaching a critical temperature. This type of chain reactions is generally complicated to control once they start, therefore the need to provide components and devices to control battery temperature.

In examples, the top cover may be made of aluminum to provide a relatively light weight component with good heat transmission properties. A plurality of cooling channels through which a liquid coolant is circulated may be formed in e.g. an extruded aluminum profile, or between two aluminum plates or sheets.

In examples, the aluminum profiles, plates or sheets, may be configured to be in contact with the battery cells, specifically through an interface material with high thermal conductivity, e.g. a sealant or filler material with high thermal conductivity.

In some examples, the battery comprises a bus bar connecting electrically the battery cells. Further, the bus bar may be configured to be at least partially located inside the battery tray. In examples, the bus bar may be almost completely located inside the battery tray. In examples, the bus bar may substantially have a U shape, comprising a first side member electrically connected to positive terminals of the battery cells, a second side member electrically connected to negative terminals of the battery cells each of the side members connected to an electrical junction, which may be located close to a central plane.

Further, in examples, the battery unit comprises a layer above the top cover configured to provide fire retardancy protection.

In another aspect, a battery system including one or more battery units as previously disclosed is provided. Thus, individual battery units of the battery system may be replaced e.g. in case of malfunctioning, whereas other components of the battery system may remain unaffected/unchanged.

In examples, each battery unit of the battery system includes or may be connected to a separate battery management system (BMS). The BMS is an electronic system that manages the battery by protecting the battery from operating outside its safe operating range. For example, the BMS may monitor voltage, temperature and current of the battery and battery cells, the cooling system and the state of balance of cells among others. Having separate BMS results in a battery system with battery units that may operate fully independent from each other.

In some examples, the battery system comprises a lower cover or lower cover component configured to cover the battery units. Thus, a single lower cover (component) protects all battery units from external impacts, dust, stones, bollards, and others. Further, the lower cover may be designed with a substantially flat bottom so that the drag coefficient of the vehicle may be reduced. This may also improve the range of the electric vehicle.

In yet another aspect, a vehicle comprising the battery system disclosed is provided.

In examples, the battery units are connected to a framework of the vehicle through releasable fasteners. Again, this allows disassembling the battery system without the need of any permanent modification in the vehicle or in the battery unit. Since each unit may be substantially independent with its own cooling system, its own busbar etc., replacement of one unit with a new unit can be relatively easily carried out.

In some examples, the vehicle may comprise a battery system including two or more battery units. Further, the vehicle may comprise at least three coupling structures configured to receive the releasable fasteners. The first and second coupling structures may be located at respective first and second sides of the battery system. Further, a third coupling structure may be located between battery units and may be configured to receive releasable fasteners from both battery units.

This vehicle configuration results in a compact design wherein two battery units may be independently mounted and connected to the vehicle. The battery units may be positioned such as to lower the center of gravity of the vehicle and distributed substantially symmetrical with respect to a central longitudinal axis of the vehicle. The coupling structures may provide a suitable connection area between battery units and vehicle, and may be integrated into the vehicle or coupled to the vehicle.

### BRIEF DESCRIPTION OF THE DRAWINGS

Non-limiting examples of the present disclosure will be described in the following, with reference to the appended figures, in which:

FIG. 1 schematically illustrates an exploded view of an example of a battery unit according to the present disclosure.

FIG. 2 schematically illustrates an exploded view of an example of a battery system according to the present disclosure.

FIG. 3 schematically illustrates a perspective bottom view of the battery system in FIG. 2 in a vehicle according to the present disclosure.

FIG. 4 schematically illustrates a cross-section across the plane A-A′ in FIG. 3.

FIG. 5 schematically illustrates a cross-section across the plane B-B′ in FIG. 3.

The figures refer to example implementations and are only be used as an aid for understanding the claimed subject matter, not for limiting it in any sense.

### DETAILED DESCRIPTION OF EXAMPLES

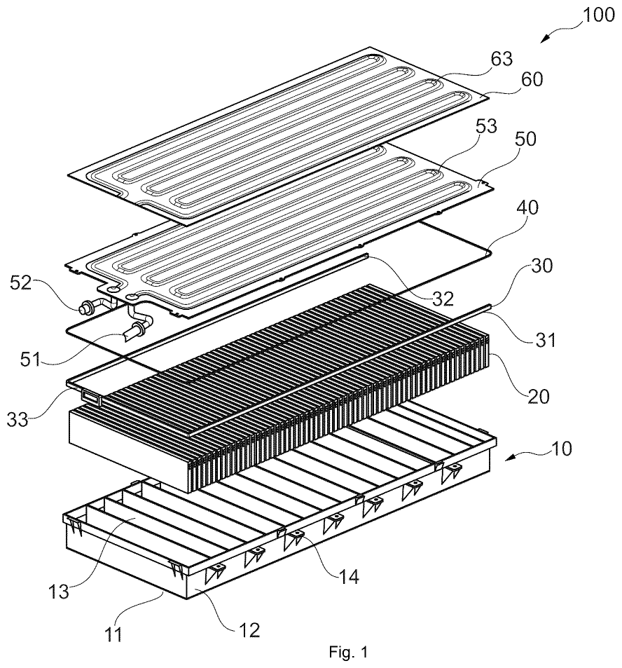

FIG. 1 schematically represents a battery unit 100 for a vehicle. The battery unit 100 comprises a battery tray 10 made of a composite material. The battery tray 10 defines an interior space configured to receive a battery 20 comprising one or more battery cells. The battery tray 10 is delimited by a bottom wall 11 and at least one lateral wall 12. Further, the battery unit 100 comprises a top cover 50 configured to close the battery tray 10. A cooling system 53 for cooling the battery 20 is integrated in the top cover 50.

The battery tray 10 is made of composite material (e.g. fiber reinforced polymers) and the composite material may be chosen and tailored to provide specific mechanical properties to the battery tray 10. For example, the composite material may comprise a layer of biaxial or triaxial fibers to increase the mechanical properties of the tray in a particular direction. Additionally, the material of the fibers and the resin may also be chosen to obtain a final product, i.e. battery tray 10, with specific mechanical and physical properties. For example, the fibers may comprise glass fibers, carbon fibers or aramid fibers among others. By choosing suitable polymers and fibers, the battery may be electrically insulated from the rest of the vehicle.

The composite battery tray 10 in some examples may be manufactured using compression molding or sheet molding compound. In this case, a sheet molding compound (SMC) may be cut into a sheet of appropriate size and located into a heated die of a mold. In examples, the heated die may be at a temperature between 130 and 160 ° C. The die(s) of the mold may then be brought together and closed exerting a pressure of between 30 and 120 bar. Thus, as material viscosity drops, the SMC flows and fills the mold cavity. Note that other techniques for which the pressure applied to the SMC is considerably lower, i.e. below 30 bar, may also be used.

SMCs made of fiber glass may be cured in between 30 seconds and 150 second after starting the forming process. Therefore, the overall manufacturing cycle can be as fast as 80 seconds, allowing high-volume production at a reduced material cost.

The composition of the SMC may be adapted to provide composite materials with improved properties. For example, carbon fibers can be introduced in the SMC to increase strength- and stiffness-to-weight ratio. Further, other additives may be also provided to prevent surface microcracks due to outgassing.

In other examples, the composite battery tray 10 may be manufactured by hand layup, which consists of placing layers of e.g. dry fabrics, by hand onto a tool (mold) to form a laminate stack. Then, resin can be applied to the dry fabrics e.g., by means of resin infusion or injection using RTM. In further examples, prepregs (fabric pre-impregnated with resin) may be used. After laying of prepreg, they may be heated and cured.

In other cases, the manufacturing process may comprise laying fabrics already coated with resin, and then debulking the stack. The debulking can be done by hand with rollers or using a vacuum-bagging technique.

It is noted that the battery tray 10 in the example of FIG. 1 also includes cross-members 13 between lateral walls 12 configured to separate battery cells or groups of battery cells. The cross-members thus act as “spacers” or “separators”. When the plurality of electric cells that make up the battery 20 are mounted inside the tray, the spacers may be helpful to separate cells from each other, and to stabilize them during assembly. Further, the cross-members 13 may be designed to provide stiffness to the tray 10.

In some examples, the battery cells may be fixed to the bottom wall 11 of the battery tray 10 using a (structural) adhesive, and the cross-members provide additional stability to the assembly. A structural adhesive may herein be regarded as a high strength glue that can bond together components in a load bearing structure.

The cross-members 13 in this example may be integrally formed with the battery tray 10. For example, the mold used to manufacture the battery tray 10 may include this geometry and the cross-members 13 may be formed by composite material. In other examples, the cross-members 13 may be made of a different material, e.g. other composite materials, or e.g. suitable polymer materials.

The cross-members may extend from the bottom wall 11 to the uppermost part of the battery tray 10 or may leave a clearance gap. Such a clearance gap may enhance air flow circulation and battery cooling. Further, the number and separation between cross-members 13 may be adapted according to several battery parameters such as number of battery cells, width of battery cells, structural requirements of the battery tray, and others.

Also illustrated in FIG. 1, the battery tray 10 may comprise brackets 14 configured to connect the battery tray 10 with a vehicle framework. The brackets may also be integrally formed with the battery tray 10 or may be coupled to the battery tray 10 after forming. In this example, the battery tray 10 comprises fourteen brackets 14, seven at two opposite sides of the battery tray 10, but other number of brackets 14 and arrangement around the battery tray 10 can be used.

In addition, FIG. 1 shows that the battery cells of the battery 20 may be electrically connected using a bus bar 30. In this example, the bus bar 30 has a substantially U shape. Thus, a first side member 31 of the bus bar 30 is electrically connected to positive terminals of the battery cells and a second side member 32 is electrically connected to negative terminals of the battery cells. Each of the side members 31, 32 may be connected to an electrical junction i.e. a main electrical connector of the battery unit. The main electrical connector may be located substantially in a central longitudinal place of the unit.

Further, the battery unit 100 in FIG. 1 shows that the top cover 50 is configured to at least partially seal the battery tray 100. In this example, the top cover 50 comprises a seal 40 substantially along a perimeter or a perimetral edge of the top cover 50. This promotes a nearly homogenous seal along the entire perimeter of the battery tray 10 and reduces the risk of liquid ingress or egress.

In some examples, the seal 40 may comprise an adhesive, e.g. the seal may adhere to the top cover 50 and then press fit into a recess in the battery tray 10. In other examples, the seal may adhere to both the top cover 50 and the battery tray 10. Further, in some cases the connection between the top cover 50 and the battery tray 10 may be achieved by a combined effect of geometry interference, e.g. press fit the seal 40 into a recess, and adhesive. Additionally, other fastening elements such as releasable fasteners may be used to mechanically secure the connection between top cover 50 and battery tray 10.

In examples, the seal 40 may be located, e.g. adhered to most of the inner surface of the top cover 50. Further, the seal 40 may also adhere to the battery tray 10. A thermally conductive adhesive may be used to connect the battery cells to the top cover to improve the thermal control over the battery cells. The adhesive in this example may thus provide sealing, structural bonding, and thermal conductivity.

In further examples, the battery tray 10 and the top cover 50 may define a substantially labyrinthic interphase to hinder even further the ingress/egress of liquid.

Additionally, the top cover 50 may be made of a metal with a relatively high thermal conductivity coefficient and relatively low density, e.g. aluminum. However, other materials or combination of material may be used for this purpose, e.g. aluminum alloys.

Further, the top cover 50 may comprise a cooling system 53 with one or more cooling channels configured to contain a liquid coolant. The cooling system may be formed by controlled atmosphere brazing (CAB). Additionally, the cooling system may be manufactured following any other suitable manufacturing process, e.g. machining a blank, soldering curved sections to a flat plate, metal molding, deforming a plate, e.g. an aluminum plate, to define open cooling channels, and coupling an additional plate (either deformed or flat) to close the cooling channels, etc.

Any suitable coolant may be used e.g. water or more elaborate compositions such as compositions comprising Ethylene glycol. In a specific example, a composition comprising 50% glycol and 50% water may be used.

As previously discussed, the composition of the coolant may be chosen to obtain a coolant with high specific heat capacity, i.e. high heat capacity per mass unit, or to obtain a coolant with high latent heat, i.e. high heat absorption during a phase transformation, and a phase transition close to the working temperature of the battery unit. Further, the coolant may have low electrical conductivity or electrically insulating properties. In examples, the coolant may be a dielectric coolant. Thus, the cooling system with cooling channels may keep the battery temperature at a suitable operating temperature i.e. temperature at which the battery does not experience problems and at which it operates efficiently. In any case, the cooling system may ensure that the temperature is maintained below the critical temperature at which the battery may experience thermal runaway.

In examples, the cooling system may also be used to heat the cells to an appropriate working temperature. For example, the cooling system may heat the cells during an initial warming up process and then cool the cells after these reach a desired working temperature.

Further, the cooling channels may have an inlet port 51 and an exit port 52 to introduce coolant at relatively low temperature and extract coolant at relatively high temperature, respectively. The inlet and exit ports 51, 52 may be connected to a heat exchanger and to a pressurization system. Each battery unit 100 as illustrated in FIG. 1 may have its own cooling system and its own thermal management system i.e. the thermal management of unit 100 may be independent from the thermal management of an adjacent unit in the same vehicle. If a unit is damages or requires repair, the unit may simply be replaced without affecting the functioning of other units in the same vehicle.

Further, the example of the battery unit 100 illustrated in FIG. 1 shows that the battery unit 100 may also comprise a layer 60 above the top cover 50 to provide fire retardancy protection and at least partially isolate the battery unit 100 from other components of the vehicle. The layer 60 may be shaped to at least partially match the geometry of the top cover 50 where the cooling channels 53 are integrated. In fact, in the present example illustrated in FIG. 1, the layer 60 may be formed by spraying a composition comprising epoxy. Thus, the composition may adapt to the geometry of the top cover before curing, resulting in a layer with substantially constant material thickness.

The layer providing fire retardancy in general may be made of a coating material. The coating material may be a composition comprising epoxy and may cure at room temperature or at higher temperature to accelerate the curing process. In examples, other materials such as fiber cloths or mica plates can be used to provide fire retardancy protection.

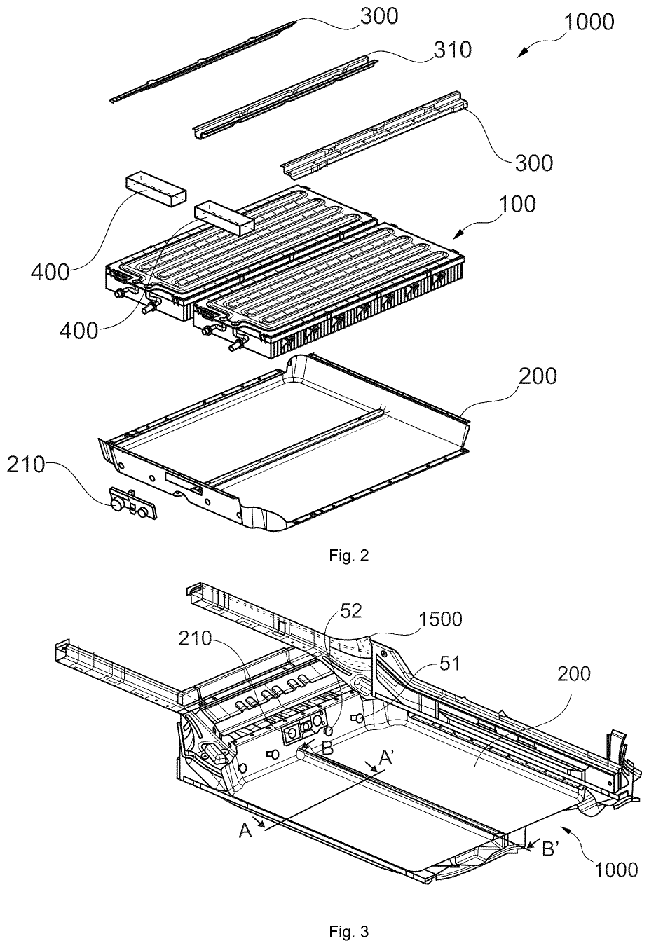

FIG. 2 is a schematic illustration of a battery system 1000 including two battery units 100. In other examples, the battery system may comprise any other number of battery units, for example three or more battery units.

In the illustrated example, the battery system 1000 comprises two battery units 100 that are substantially similar, but in other examples the battery system 1000 may comprise battery units 100 of different specifications, including the number of cells, battery capacity, battery dimensions and others.

In the illustrated example of battery system 1000, each battery unit 100 comprises a separate battery management system 400. Note that the battery management system has been schematically illustrated, and that the connections between the battery and the battery management system have not been illustrated. As previously discussed, the battery management system may be configured to monitor voltage, temperature and current of the battery and battery cells, the cooling system and the state of balance of cells among others. Further, the battery management system may be configured to send control signals to other electronic components of the battery unit to modify any of the aforementioned parameters or others.

Thus, the battery system 1000 may comprise more than one battery unit 100 that may be considered as an independent unit, i.e. a battery unit may operate the vehicle without affecting other battery units, particularly in terms of electrical operation (power, voltage, currents etc. and in terms of cooling).

Further, the battery system 1000 may comprise a lower cover 200 configured to cover the battery units 100. The lower cover 200 may protect the battery units 100 against impacts from underneath the vehicle. The lower cover 200 may be a metal component, e.g. a hot stamped metal component.

In some examples, the lower cover 200 may be made of a boron steel like 22MnB5 steel with or without protective coating (e.g. Usibor® 1500 as commercially available from Arcelor Mittal), or 37MnB 5 steel (e.g. Usibor® 2000) or any martensitic steel or ultra high strength steel (UHSS).

Usibor® 1500 and similar 22MnB5 steels are generally supplied in ferritic-perlitic phase. It is a fine grain structure distributed in a homogenous pattern. Its mechanical properties are related to this structure. After heating, a hot stamping process and subsequent quenching, a martensite microstructure is created. As a result, tensile strength and yield strength increase noticeably.

The composition of Usibor® 1500 is summarized below in weight percentages (the rest is iron (Fe) and impurities):

Maximum carbon (C) (%): 0.25

Maximum silicon (Si) (%): 0.4

Maximum manganese (Mn) (%): 1.4

Maximum phosphorus (P) (%): 0.03

Maximum sulphur(S) (%): 0.01

Aluminium (Al) (%): 0.01-0.1

Maximum titanium (Ti) (%): 0.05

Maximum niobium (Nb) (%): 0.01

Maximum copper (Cu) (%): 0.20

Maximum boron (B) (%): 0.005

Maximum chromium (Cr) (%): 0.35

Usibor® 2000 is another boron steel with even higher strength. After a hot stamping die quenching process, the yield strength of Usibor® 2000 may be 1300 MPa or more, and its ultimate tensile strength may be above 1800 MPa.

The composition of Usibor® 2000 is summarized below in weight percentages (rest is iron (Fe) and impurities):

Maximum carbon (C) (%): 0.36

Maximum silicon (Si) (%): 0.8

Maximum manganese (Mn) (%): 0.8

Maximum phosphorus (P) (%): 0.03

Maximum sulphur(S) (%): 0.01

Aluminium (AI) (%): 0.01-0.06

Maximum titanium (Ti) (%): 0.07

Maximum niobium (Nb) (%): 0.07

Maximum copper (Cu) (%): 0.20

Maximum boron (B) (%): 0.005

Maximum chromium (Cr) (%): 0.50

Maximum molybdenum (Mb) (%): 0.50

22MnB5 may be presented with an aluminum-silicon coating in order to avoid decarburization and scale formation during the forming process. Several 22MnB5 steels are commercially available having a similar chemical composition. However, the exact amount of each of the components in a 22MnB5 steel may vary slightly from one manufacturer to another. Other ultra high strength steels include e.g. BTR 165, commercially available from Benteler.

Further, the lower cover 200 may be made of other high strength steels. For example, Fortiform® steels may also be used to manufacture the lower cover 200 by a cold forming process. A lower cover 200 made of Fortiform® may provide additional weight reduction compared with a component made of DP steels with similar mechanical properties. Furthermore, Fortiform® steels exhibit excellent fatigue properties on account of their very high mechanical strength. Fortiform® steels are commercially available from ArcelorMittal.

In some examples, the lower cover 200 may be made of Fortiform®, e.g. the lower cover 200 may be made of Fortiform® 1180(HF1180Y850), which has a tensile strength of −1330 MPa. In other examples, the lower cover 200 may be made of Fortiform® S1270, which has a tensile strength of 1270-1400 MPa.

The composition of Fortiform® 1180 is summarized below in weight percentages (rest is iron (Fe) and impurities):

Maximum carbon (C) (%): 0.23

Maximum silicon (Si) (%): 2.0

Maximum manganese (Mn) (%): 2.9

Maximum phosphorus (P) (%): 0.040

Maximum sulphur(S) (%): 0.010

Aluminium (Al) (%): 0.015-1.0

Maximum titanium plus niobium (Ti+Nb) (%): 0.15

Maximum niobium (Nb) (%): 0.10

Maximum copper (Cu) (%): 0.20

Maximum boron (B) (%): 0.005

Maximum chromium plus molybdenum (Cr+Mo) (%): 0.60

The composition of Fortiform® S1270 is summarized below in weight percentages (rest is iron (Fe) and impurities):

Maximum carbon (C) (%): 0.21

Maximum silicon (Si) (%): 1.5

Maximum manganese (Mn) (%): 4.1

Maximum phosphorus (P) (%): 0.04

Maximum sulphur(S) (%): 0.01

Aluminium (Al) (%): 0.015-1.0

Maximum titanium plus niobium (Ti+Nb) (%): 0.15

Maximum niobium (Nb) (%): 0.10

Maximum copper (Cu) (%): 0.2

Maximum chromium plus molybdenum (Cr+Mo) (%): 0.6

Steels suitable for hot forming and for cold forming with other material compositions may be also used to manufacture the lower cover 200.

Further, the lower cover 200 may have an electric adaptor to connect the battery units to other components of the vehicle. The electric adaptor may have a plurality of ports. In some examples, the ports may be configured to provide a different electric output, i.e. the maximum voltage and/or current provided by each port may be different.

In some examples, the lower cover 200 may comprise a vent, e.g. an additional port (not illustrated), to allow battery gases escaping to the atmosphere. Further venting devices configured for the same purpose may also be used in the battery tray 10.

Further, FIG. 2 also illustrates coupling structures 300, 310 of the vehicle. The coupling structures 300, 310 are configured to receive releasable fasteners so that the battery system may be coupled with the vehicle. These structures will be discussed in more detail in relation with FIGS. 3 to 5.

FIG. 3 schematically illustrates a perspective bottom view of an example of a vehicle framework 1500 of a vehicle according to the present disclosure. Note that other vehicle components that are not mechanically coupled with the battery system 1000 have not been illustrated for the purposes of simplicity.

The vehicle in this example comprises a battery system 1000 including two battery units covered by a lower cover 200. In this example, the lower cover 200 also comprises other openings configured to receive the electric adaptor 210 and the inlet and exit ports 51, 52 of the cooling systems.

Also illustrated in FIG. 3, the lower cover 200 may have a substantially flat bottom. Thus, the underbody of the vehicle may remain substantially flat, enhance the aerodynamic performance of the vehicle. In other examples, the lower cover 200 may be adapted to adjust progressively to an underbody diffuser of the vehicle.

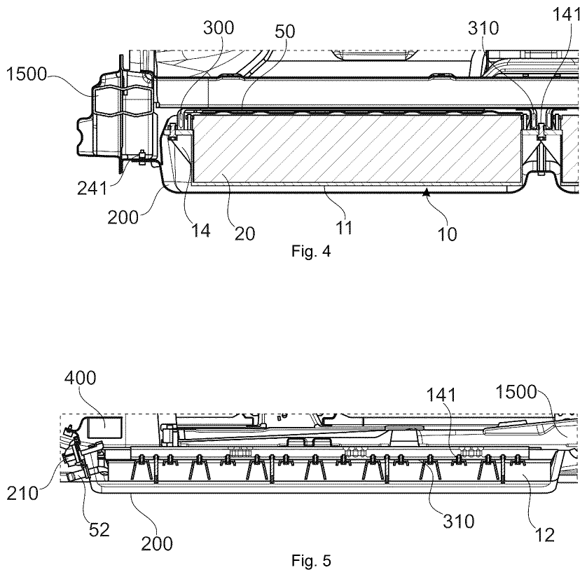

FIG. 4 schematically illustrates a cross-section across the plane A-A′ in FIG. 3. In this figure, only half of the vehicle framework 1500 and battery system 1000 have been illustrated.

FIG. 4 shows that the battery tray 10 may be connected to the coupling structures 300, 310 through releasable fasteners 141. In this example, the brackets 14 of the battery tray 10 are the elements of the battery tray 10 configured to receive the fasteners 141 and hold the battery tray 10 in place. Additionally, the lower cover 200 may also comprise a flange configured to receive releasable fasteners 241 and connect the lower cover 200 with the vehicle framework 1500. Thus, in case a qualified operator needs to access the interior of the battery system 1000, the operator may release the fasteners 241 of the lower cover 200, remove the lower cover 200 and disassemble a specific battery unit 100 from the remainder of the vehicle. The battery unit 100 may be replaced by another battery unit if necessary. The operation of the adjacent battery unit is substantially independent (in terms of electrical control and in terms of cooling) from the new battery unit and is thus substantially unaffected.

Further, FIG. 4 shows that the bottom wall 11 of the battery tray 10 may be separated from the lower cover 200. Thus, any impact that receives the lower cover 200 is not directly transmitted to the battery tray 10. In other examples, an intermediate cushioning layer e.g. involving foam or honeycomb material may be located between the lower cover 200 and the bottom wall 11 of the battery tray 10.

FIG. 4 partially shows the arrangement of the coupling structures 300, 310. More precisely, FIG. 4 illustrates that the vehicle may comprise at least three coupling structures 300, 310 (one not illustrated). A first and second coupling structure 300 may be located at respective first and second sides of the battery system 1000, and a third coupling structure 310 may be located between battery units 100 of the battery system 1000.

Thus, each one of the first and second coupling structure 300 may be configured to secure a respective battery unit 100 to a side structure (depending on the vehicle framework, this might be e.g. a rocker) and the third coupling structure 310 may be configured to secure both battery units 100 to each other and to the framework of the vehicle.

The coupling structures may be configured to receive releasable fasteners and therefore the battery system may be assembled and disassembled several times to the vehicle without incurring in any structural modification of the same.

In examples, the coupling structures may be made of extrusion profiles, e.g. aluminum extrusion profiles.

FIG. 5 schematically illustrates a cross-section across the plane B-B′ in FIG. 3.

The coupling structures 310 of the vehicle may substantially extend along the entire length of the battery tray 10 to facilitate the connection between the battery tray 10 and the vehicle. In other examples, the coupling structures 310 may be substantially shorter than the battery tray 10 and a plurality of coupling structures 310 may be distributed along the length of the battery tray 10.

In examples, the coupling structures 300, 310 may be coupled to the vehicle framework 1500 by welding, e.g. spot welding, but other approaches may also be used. For example, the coupling structures 300, 310 may be integrally formed in the vehicle framework. Further, the coupling structures 300, 310 may be made of a metal with high mechanical properties. For example, the coupling structures 300, 310 may be made of suitable steels (boron steels like 22MnB5 or 37MnB5 or others) as previously discussed in relation to the lower cover 200.

FIG. 5 also illustrates that the lower cover 200 may be adapted to receive other components of the battery system 1000, e.g. it may include openings for the ports 51, 52 of the cooling system 53 and for the electric adaptor 210.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A battery unit for a vehicle, the battery unit comprising:
a battery tray made of a composite material and defining an interior space configured to receive a battery comprising one or more battery cells and, the interior space being delimited by a bottom wall and one or more lateral walls, and the battery tray comprising cross-members configured to separate the battery cells and being integrally formed with the battery tray, and
a top cover configured to close the battery tray, wherein
a cooling system for cooling the battery is integrated in the top cover, and wherein
the top cover comprises a seal at least substantially along a perimeter of the top cover, wherein the seal is a thermally conductive seal and is arranged to contact the top cover and the battery cells.

2. The battery unit of claim 1, wherein the battery tray is made of a sheet molding compound.

3. The battery unit of claim 1, wherein the composite material comprises glass fiber.

4. The battery unit of claim 1, wherein the battery tray comprises brackets configured to connect the battery tray with a vehicle framework.

5. The battery unit of claim 1, wherein the top cover is made of aluminum.

6. The battery unit of claim 1, wherein the seal comprises an adhesive.

7. The battery unit of claim 1, wherein the battery comprises a bus bar connecting electrically the battery cells, the bus bar being at least partially located inside the battery tray.

8. The battery unit of claim 7, wherein the bus bar has a substantially U shape, comprising a first side member electrically connected to positive terminals of the battery cells, a second side member electrically connected to negative terminals of the battery cells.

9. A battery system including one or more battery units, the battery units comprising:
a battery tray made of a composite material and defining an interior space configured to receive a battery comprising one or more battery cells and, the interior space being delimited by a bottom wall and one or more lateral walls, and the battery tray comprising cross-members configured to separate the battery cells and being integrally formed with the battery tray, and
a top cover configured to close the battery tray, wherein
a cooling system for cooling the battery is integrated in the top cover, and wherein
the top cover comprises a seal at least substantially along a perimeter of the top cover, wherein the seal is a thermally conductive seal and is arranged to contact the top cover and the battery cells.

10. The battery system of claim 9, wherein each battery unit comprises a separate battery management system.

11. The battery system of claim 9, wherein the battery system comprises a lower cover configured to cover the battery units.

12. A vehicle comprising a battery system, the battery system including one or more battery units, the battery units comprising:
a battery tray made of a composite material and defining an interior space configured to receive a battery comprising one or more battery cells and, the interior space being delimited by a bottom wall and one or more lateral walls, and the battery tray comprising cross-members configured to separate the battery cells and being integrally formed with the battery tray, and
a top cover configured to close the battery tray, wherein
a cooling system for cooling the battery is integrated in the top cover, and wherein the top cover comprises a seal at least substantially along a perimeter of the top cover, wherein the seal is a thermally conductive seal and is arranged to contact the top cover and the battery cells.

13. The vehicle of claim 12, wherein the battery units are connected to a framework of the vehicle through releasable fasteners.

14. The vehicle of claim 13, wherein the battery system includes two battery units, and wherein the vehicle further comprises at least three coupling structures configured to receive the releasable fasteners, wherein a first and second coupling structure are located at respective first and second sides of the battery system and a third coupling structure is located between the two battery units and is configured to receive releasable fasteners from both battery units.

15. The battery system of claim 9, wherein the composite material comprises glass fiber and wherein the top cover is made of aluminum.

16. The battery system of claim 9, wherein the battery tray comprises brackets configured to connect the battery tray with a vehicle framework.

17. The battery system of claim 9, wherein the seal comprises an adhesive.

18. The battery system of claim 9, wherein the battery tray is made of a sheet molding compound.
